(19) United States
(12) Patent Application Publication
(10) Pub. No.: US 2003/0066859 A1
(43) Pub. Date: Apr. 10, 2003

(54) Nail guiding surface for guding nails of pneumatic tools

(76) Inventors: Tien-Long Chang, Taichung City (TW); Chi-tien Lin, Taichung City (TW)

Correspondence Address: CHARLES E. BAXLEY, ESQUIRE, 5TH FL., 59 JOHN STREET, NEW YORK, NY, 10038, US

(21) Appl. No.: 09/972,818

(22) Filed: Oct. 9, 2001

(51) Int. Cl. B25C 5/02

(52) U.S. Cl. 227/119; 227/120

(57) ABSTRACT

A nail guiding device for pneumatic tools includes a barrel connected to a pneumatic nailer and an opening is defined through the barrel so that a magazine is engaged with the opening. Nails connected by a connection chain are received in the magazine. A guiding surface is defined in an inside of the opening and located perpendicular to an axis of the barrel. A surface of the connection chain of the second nail in the opening is matched with the guiding surface so that the second nail is smoothly sent into the barrel to be ejected.

### FIELD OF THE INVENTION

The present invention relates to a guiding surface defined in an inside of the opening for being engaged with a magazine. The surface is perpendicular to an axis of the barrel so as to guide the second nail in correct position.

### BACKGROUND OF THE INVENTION

A conventional pneumatic nailer is shown in FIG. 1 and generally includes a barrel 10 connected to a nose portion of the power nailer and a magazine 11 is snapped to an opening 101 defined in the barrel 10 of the nailer so as to feed nails 12 received in the magazine into the barrel 10 to be ejected. The nails 12 are connected with each other by a connection chain 13 so that when the first nail 151 is ejected, the second nail 152 is then pulled toward the barrel 10. A guiding surface 102 is defined in an inside of the opening 101 and parallel with the axis of the magazine 11 which is connected to the barrel 10 at an angle. The connection chain 102 of the second nail 152 contacts the guiding surface 102 and is ready for being pulled into the barrel 10. As shown in FIG. 2, when the first nail 151 is ejected, the connection chain 13 pulls the second nail 152 and the connection chain 13 of the second nail 152 contacts the guiding surface 102 at one point. In other words, the second nail 152 is tilted when it is pulled into the barrel 10. This makes the movement of the connection chain 13 not smooth enough and affects the point of the first nail 151 to slightly face downward. Thus the ejected nail could be stock in the barrel 10.

### SUMMARY OF THE INVENTION

In accordance with one aspect of the present invention, there is provided a nail guiding device comprising a barrel connected to a pneumatic nailer and an opening is defined through the barrel so as to connect a magazine. A guiding surface is defined in an inside of the opening and located perpendicular to an axis of the barrel.

The primary object of the present invention is to provide a nail guiding surface in the inside of the opening of the barrel such that the surface of the connection chain of the second nail is matched with the guiding surface and the second nail in the opening can be smoothly sent in the barrel.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a cross sectional view to show a magazine engaged with an opening of a conventional nailer;

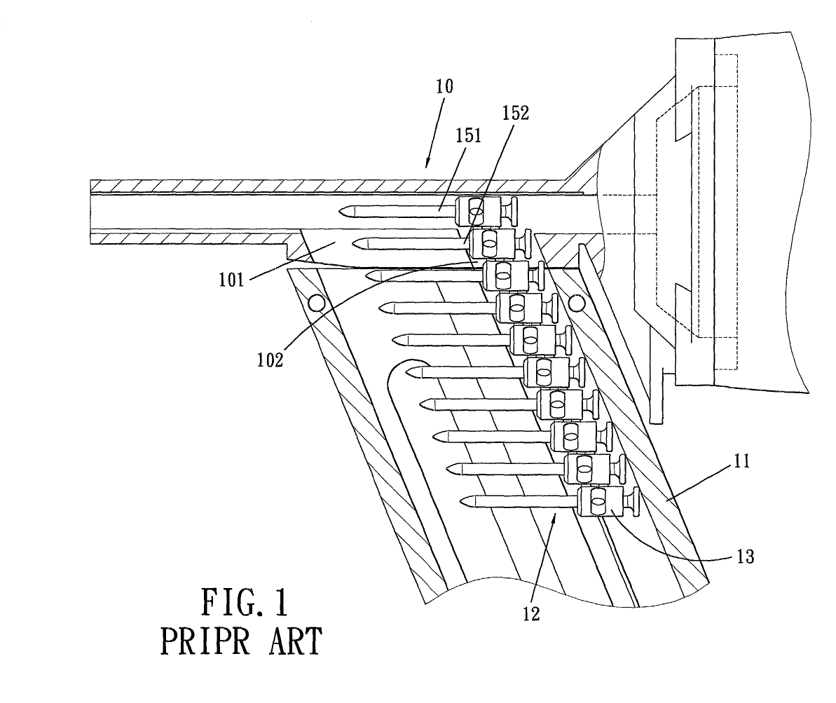

FIG. 2 is a cross sectional view to show the first nail is ejected and the second nail is tilted by the guiding surface;

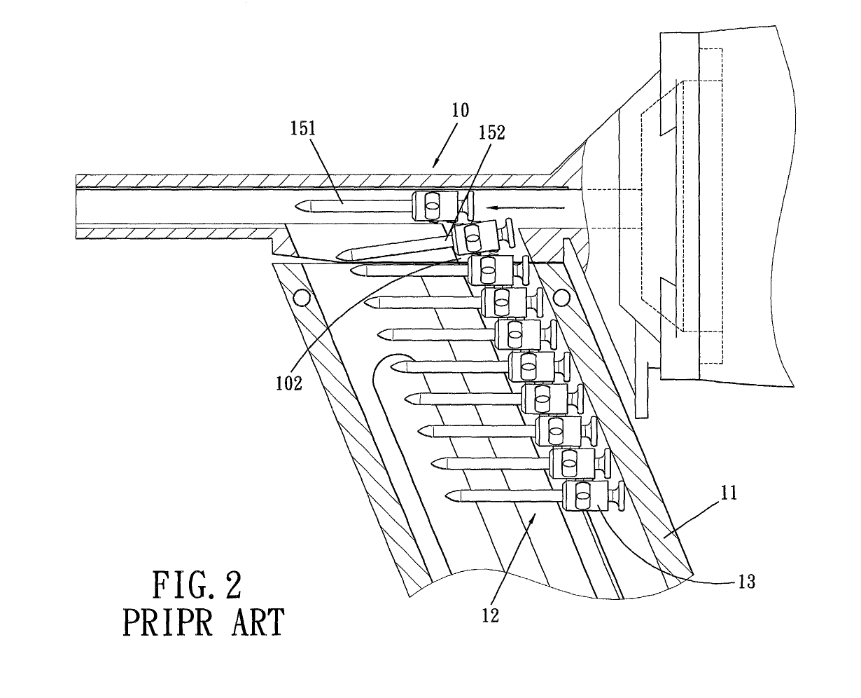

FIG. 3 is a cross sectional view to show a magazine engaged with an opening of the nailer of the present invention, and

FIG. 4 is a cross sectional view to show the first nail is ejected and the second nail is not tilted by the guiding surface.

### DETAILED DESCRIPTION OF THE PREFERRED EMBODIMENT

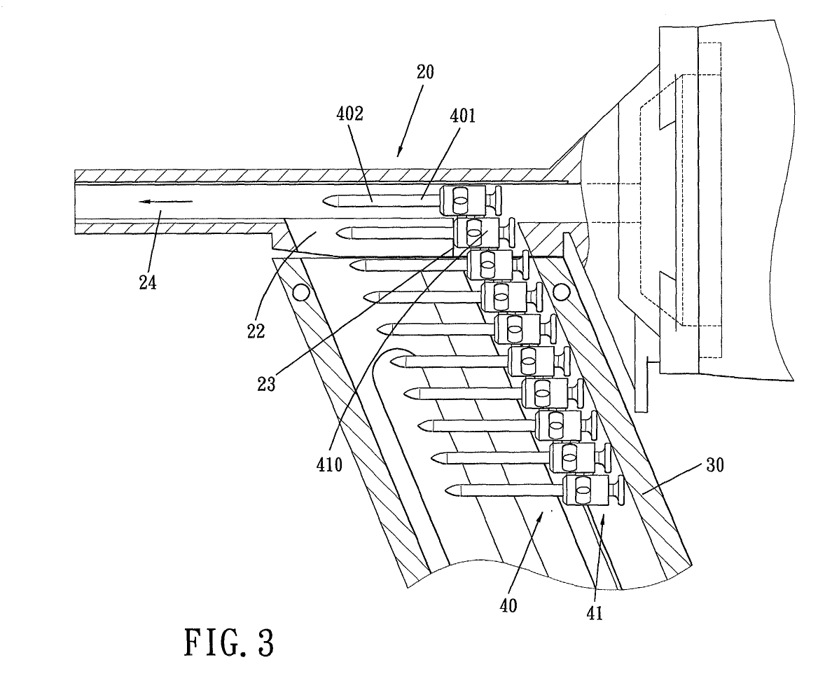

Referring to FIG. 3, the pneumatic nailer of the present invention comprises a barrel 20 connected to a pneumatic nailer and an opening 22 defined through the barrel 20. A magazine 30 is engaged with the opening 22 at an angle and nails 40 are received in the magazine 30. The nails 40 are connected by a connection chain 41 which includes a plurality of tubular sleeves 410 and each sleeve 410 receives a nail 40. A guiding surface 23 defined in an inside of the opening 22 and located perpendicular to an axis 24 of the barrel 20.

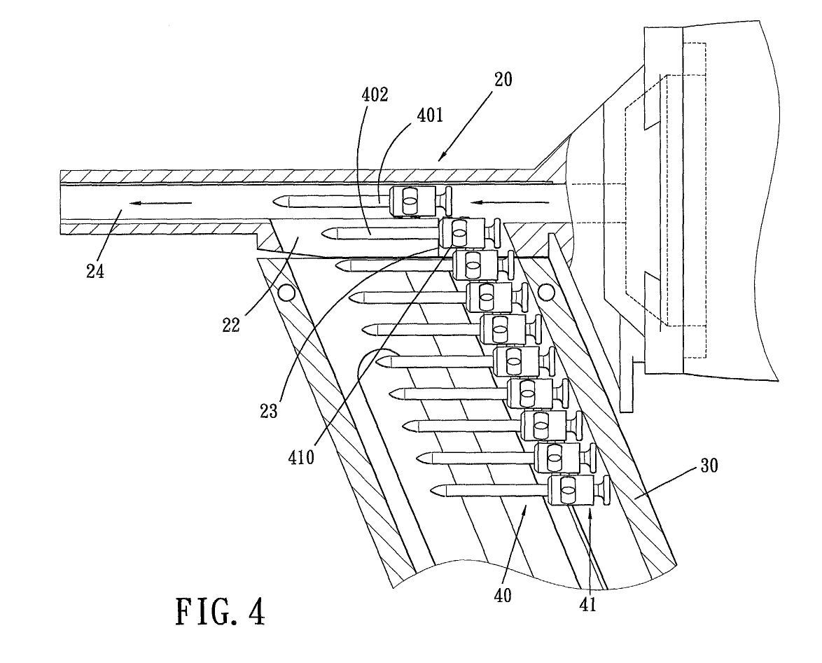

When the trigger of the pneumatic nailer is not squeezed, the first nail 401 is located in the barrel 20 to be ejected, and the second nail 402 is then located in the opening 22. A front surface of the sleeve 410 of the second nail 402 is fully matched with the guiding surface 23. As shown in FIG. 4, when the trigger is squeezed, the first nail 401 is moved toward the outlet of the barrel 20 and the connection chain 41 pulls the second nail 402 toward the barrel 20. The front surface of the sleeve 410 mounting on the second nail 402 is then steadily moved along the guiding surface 23 so that the second nail 402 is sent into the barrel 20 without any inclination.

While we have shown and described the embodiment in accordance with the present invention, it should be clear to those skilled in the art that further embodiments may be made without departing from the scope of the present invention.

What is claimed is:

1. A nail guiding device comprising:
a barrel adapted to be connected to a pneumatic nailer and an opening defined through said barrel so as to be adapted to connect a magazine;
a guiding surface defined in an inside of said opening and located perpendicular to an axis of said barrel.
